(19) United States
(12) Patent Application Publication
(10) Pub. No.: US 2006/0146115 A1
(43) Pub. Date: Jul. 6, 2006

(54) Cylindrical unit and intermediate connector

(75) Inventor: Hisashi Igi, Nagoya-shi (JP)

Correspondence Address: BANNER & WITCOFF, LTD.;ATTORNEYS FOR CLIENT NOS. 0166889, 006760, 1001 G STREET, N.W., 11TH FLOOR, WASHINGTON, DC, 20001-4597, US

(73) Assignee: Brother Kogyo Kabushiki Kaisha, Nagoya-shi (JP)

(21) Appl. No.: 11/300,486

(22) Filed: Dec. 15, 2005

(30) Foreign Application Priority Data
Dec. 17, 2004 (JP) 2004-366647

(51) Int. Cl. B41J 32/00

(52) U.S. Cl. 347/214; 400/208

(57) ABSTRACT

A cylindrical unit is provided. The cylindrical unit includes a core tube around which the ink sheet is rolled, and an intermediate connector that is attached to one end of the core tube to transmit external rotating force to the core tube, the intermediate connector being rotated integrally with the core tube by the rotating force. The core tube is provided with at least one core tube side engaging portion on an inner peripheral surface thereof. The intermediate connector is provided with at least one connector side engaging portion that is adapted to be engaged, with the at least one core tube side engaging portion. The intermediate connector is restricted from being separated from the core tube when the at least one core tube side engaging portion and the at least one connector side engaging portion are engaged with each other.

### CROSS REFERENCE TO RELATED APPLICATION

This application claims priority from Japanese Patent Application No. 2004-366647, filed on Dec. 17, 2004, the entire subject matter of which is incorporated herein by reference.

### BACKGROUND OF THE INVENTION

1. Technical Field

Aspects of the invention relate to an ink sheet cylindrical unit and an intermediate connector thereof used in an imaging apparatus such as a printing device and a facsimile machine.

2. Related Art

In general, a thermal transfer printer employs an ink sheet cartridge which eases replacement of an ink sheet, i.e., handling of the thermal printer. When the thermal printer is configured as a line printer, a wide ink sheet is used. A conventional ink sheet cartridge includes a supply core tube, a take-up core tube, and a cartridge frame. Spools are attached to both ends of the supply core tube and the take-up core tube so that each of the core tubes is rotatably attached via the spools to a pair of bearing portions oppositely arranged on right and left side walls of the cartridge frame.

When the ink sheet is used to the end, the take-up core tube that has the used ink sheet rolled around it and the supply core tube are taken out of the cartridge frame. Then, a new ink sheet set with a take-up core tube and a supply core tube having a new ink sheet rolled around it is attached to the cartridge frame.

The take-up core tube is designed to roll up the used ink sheet at a predetermined speed during a printing operation. For this operation, the take-up core tube is provided with a spool (hereinafter referred to as a driving spool) that transmits external rotating force to the take-up core tube. Further, the take-up core tube is generally provided with an intermediate connector that conveys the rotating force from the driving spool to the take-up core tube.

With the above configuration, the intermediate connector and the take-up core tube are integrally rotated as the rotating force is conveyed to the driving spool. When the ink sheet is exchanged, an intermediate connector provided to a take-up core tube of a new ink sheet set is attached to the driving spool.

During the exchange, if the take-up core tube and the intermediate connector are improperly connected, the rotating force from the driving spool is not properly conveyed to the take-up core tube, which may result an erroneous condition, such that only the intermediate connector rotates and the take-up core tube does not rotate properly, and thus, printing quality to paper medium may be deteriorated. To prevent such an erroneous condition, the intermediate connector is required to be in a configuration such that the intermediate connector is attached properly and firmly to the take-up core tube.

An example of such a configuration is disclosed in Japanese Patent Provisional Publication No. P2001-277627A. The intermediate connector in the publication has a resilient pawl, which engages with a mating groove formed at an end portion of the take-up core tube. With this configuration, the resilient pawl and the mating groove are engaged, and the intermediate connector is properly and firmly attached to the take-up core tube.

In the above mentioned configuration, when the intermediate connector is inserted into the take-up core tube, the resilient pawl is inserted into the mating groove by utilizing elastic deformation of the resilient pawl so that the pawl portion is hooked to the mating groove. For this reason, the width of an axial groove portion of the mating groove needs to be larger than the width of the arm portion of the resilient pawl. Accordingly, when the resilient pawl is engaged with the mating groove, a clearance is formed between the arm portion of the resilient pawl and inside surfaces of the mating groove. Such a configuration may cause a problem that when force is applied on the resilient pawl from an incorrect direction, for example, during replacement work of the ink sheet, the resilient pawl disengages from the mating groove, and thereby the intermediate connector disengages from the take-up core tube.

Further, the engaged portion of the resilient pawl and the mating groove is exposed from the side portion of the take-up core tube. Therefore, an incidental shock or contact to the engaged portion, which is for example caused by a user during the exchange of the ink sheets, may cause the resilient pawl and the mating groove to be disengaged, and the intermediate connector may be removed from the take-up core tube, or may be improperly engaged.

### SUMMARY OF THE INVENTION

Aspects of the present invention are advantageous in that a cylindrical unit and an intermediate connector thereof for an ink sheet cartridge that are securely engaged with each other to transmit external rotating force via the intermediate connector to the core tube properly are provided.

### BRIEF DESCRIPTION OF THE ACCOMPANYING DRAWINGS

FIG. 1 is a cross-sectional side view of an entire facsimile machine according to an illustrative embodiment of the invention.

FIG. 2 is a perspective view of an ink sheet cartridge according to the illustrative embodiment of the invention.

FIG. 3 is a side view of the ink sheet cartridge according to the illustrative embodiment of the invention.

FIG. 4 is another side view of the ink sheet cartridge according to an illustrative embodiment of the invention.

FIG. 5 is an exploded perspective view of the ink sheet cartridge according to the illustrative embodiment of the invention.

FIG. 6 is an exploded perspective view of components of the ink sheet cartridge according to the illustrative embodiment of the invention.

FIGS. 7A-7E illustrate diagrams of an intermediate connector according to the illustrative embodiment of the invention.

FIGS. 8A-8D illustrate diagrams of an take-up core tube according to the illustrative embodiment of the invention.

FIGS. 9A-9C illustrate diagrams of a process to insert the intermediate connector into the take-up core tube according to the illustrative embodiment of the invention.

FIG. 10 illustrates a stress distribution in the intermediate connector according to the illustrative embodiment of the invention.

FIGS. 11A-11C illustrate diagrams of a take-up cylinder with the intermediate connector inserted into the take-up core tube according to the illustrative embodiment of the invention.

FIGS. 12A-12D illustrate diagrams of a rotating member according to the illustrative embodiment of the invention.

FIGS. 13A-13C illustrate diagrams of a flanged shaft member according to the illustrative embodiment of the invention.

### DETAILED DESCRIPTION

General Overview of Aspects of the Invention

The following describes general aspects of the invention that may or may not be included in various embodiments/modifications. Also, it is noted that various connections are set forth between elements in the following description. It is noted that these connections in general and, unless specified otherwise, may be direct or indirect and that this specification is not intended to be limiting in this respect.

According to some aspects of the invention, there is provided a cylindrical unit. The cylindrical unit includes a core tube around which the ink sheet is rolled, and an intermediate connector that is attached to one end of the core tube to transmit external rotating force to the core tube, the intermediate connector being rotated integrally with the core tube by the rotating force. The core tube is provided with at least one core tube side engaging portion on an inner peripheral surface thereof. The intermediate connector is provided with at least one connector side engaging portion that is adapted to be engaged, with the at least one core tube side engaging portion. The intermediate connector is restricted from being separated from the core tube when the at least one core tube side engaging portion and the at least one connector side engaging portion are engaged with each other.

The intermediate connector and the core tube is connected when the connector side engaging portion and the core tube side engaging portion are engaged to each other. The engaged portion is configured inside the core tube and not exposed to the outside of the core tube. Therefore, an incidental shock or contact to the engaged portion, which is for example caused by a user during exchange of ink sheets, can be avoided, and the engagement of the intermediate connector and the core tube is secured. As the engagement of the intermediate connector and the core tube is securely maintained, rotating force via the intermediate connector to the core tube is properly conveyed.

The at least one core tube side engaging portion may be formed as a male engaging portion that protrudes from the inner peripheral surface of the core tube toward a center of a diameter of the core tube. The at least one connector side engaging portion may be formed as a female engaging portion that is recessed at a location corresponding to the male engaging portion. The intermediate connector may be restricted from being separated from the at core tube when the male engaging portion and the female engaging portion are engaged with each other.

As the recessed portion as the female engaging portion is formed in the intermediate connector, and the protrusion as the male engaging portion is formed in the core tube, the core tube, particularly the male engaging portion, can be formed in a less complicated manner than a manner in which the core tube with the female engaging portion is formed.

The intermediate connector may include an inserted portion that is inserted into the inside of the core tube, and a rib portion that is extended in a longitudinal direction from the inserted portion. The rib portion may be resiliently deformed toward the center of the diameter of the core tube by stress caused by the at least one male engaging portion. The female engaging portion may be formed on a surface of the rib portion at a position opposed to the inner peripheral surface of the core tube.

With the above configuration, the intermediate connector and the core tube are in a secure engagement. In addition, the engagement of the intermediate connector and the core tube can be obtained in a simple operation.

The intermediate connector may be configured to be resiliently deformed by stress caused by the at least one male engaging portion when the rib portion is inserted into the core tube and to be raised from the inner peripheral surface of the core tube to a height of the male engaging portion, and to recover to an original form thereof when the rib portion is further inserted during a process to engage the intermediate connector with the core tube. The height of the male engaging portion and a length of the rib portion from a boundary between the inserted portion and the rib portion to an edge of the female engaging portion that is closer to a tip of the rib portion may be configured so that when the male engaging portion and the female engaging portion are being engaged with each other, possible temporal stress to the rib portion caused by being deformed is smaller than and close to a maximum allowable stress to the rib portion.

The maximum allowable stress refers to the greatest value of stress in a range that allows the deformed rib portion to recover to the original form thereof. When stress greater than the maximum allowable stress is applied to the rib portion, the rib portion is plastically deformed.

When the male engaging portion and the female engaging portion are engaged as described above, the rib portion is required to be resiliently deformed toward the center of the diameter of the core tube to be separated from the inner peripheral surface of the core tube. In such case, the stress caused in the rib portion is close to the maximum allowable stress, which causes difficulty in disengaging the female engaging portion from the male engaging portion. Thus, the female engaging portion and the male engaging portion are more securely engaged.

The intermediate connector may be made of resin. The height of the male engaging portion from the inner peripheral surface toward the center of the diameter of the core tube may be in a range from 0.95 mm to 1.1 mm.

With the above described configuration, the stress applied to the rib portion when the edge of the female engaging portion is raised for the height of the male engaging portion from the surface of the inner peripheral surface of the core tube is close to the maximum allowable stress, therefore, the female engaging portion and the male engaging portion are more securely engaged.

A circumferential length of the rib portion at the boundary with the inserted portion may be configured to be in a range from 1/10 to ¼ of an entire circumferential length of the inserted portion. The length of the rib portion from the boundary between the inserted portion and the rib portion to the edge of the female engaging portion may be configured to be in a range from 7.5 mm to 15 mm.

The length of the rib portion from the boundary between the inserted portion and the rib portion to the edge of the female engaging portion may be configured to be in a range from 7.8 mm to 8.8 mm.

The at least one core tube side engaging portion may be provided in a vicinity of a first end of two ends of the core tube. The intermediate connector may be allowed to be attached to the first end of the core tube. The intermediate connector may not be allowed to be attached to a second end of the core tube.

With the above described configuration, the intermediate connector is not allowed to be inserted by mistake to the core tube from an incorrect end where the male engaging portion is not formed.

An inner diameter of the core tube at the second end may be configured to be smaller than an inner diameter of the core tube at the first end, so that the intermediate connector is allowed to be correctly inserted into the core tube.

It should be noted that an outer diameter of the inserted portion is substantially equal to an inner diameter of the core tube at the first end. With the above described configuration, the intermediate connector is not allowed to be inserted by mistake to the core tube from the incorrect end. In addition, it should be noted that the user can recognize the correct end of the core tube to attach the intermediate connector with the simple configuration.

The intermediate connector may be provided with a maximum diameter portion of which a diameter thereof is equal to an external diameter of the core tube, and at least one protruding segment that is inserted in a groove formed on the core tube.

With the above described configuration, the intermediate connector is allowed to clutch the core tube more securely and to rotate along with the core tube. Therefore, idling of the intermediate connector can be avoided. It should be also noted that a position of the intermediate connector relative to the core tube can be determined by the groove; therefore the male engaging portion and the female engaging portion can be engaged effectively.

The core tube may be integrally formed of resin.

With this configuration, the core tube can be formed in a less complicated manner than a manner in which the core tube is formed in a metal, for example iron and aluminum. In addition, the core tube made of resin may be more advantageous in reduction of weight and production cost.

According to some aspects of the invention, there is provided an ink sheet cartridge. The ink sheet cartridge includes a cylindrical unit with a core tube around which the ink sheet is rolled, and an intermediate connector that is attached to one end of the core tube to transmit external rotating force to the core tube, the intermediate connector being rotated integrally with the core tube by the rotating force. The core tube is provided with at least one core tube side engaging portion on an inner peripheral surface thereof. The intermediate connector is provided with at least one connector side engaging portion that is adapted to be engaged, with the at least one core tube side engaging portion. The intermediate connector is restricted from being separated from the core tube when the at least one core tube side engaging portion and the at least one connector side engaging portion are engaged with each other.

According to some aspects of the invention, there is provided an ink sheet set. The ink sheet set includes a cylindrical unit with a core tube around which an ink sheet is rolled, and an intermediate connector that is attached to one end of the core tube to transmit external rotating force to the core tube, the intermediate connector being rotated integrally with the core tube by the rotating force. The core tube is provided with at least one core tube side engaging portion on an inner peripheral surface thereof. The intermediate connector is provided with at least one connector side engaging portion that is adapted to be engaged with the at least one core tube side engaging portion. The intermediate connector is restricted from being separated from the core tube when the at least one core tube side engaging portion and the at least one connector side engaging portion are engaged with each other.

According to some aspects of the invention, an imaging apparatus is provided. The imaging apparatus includes an ink sheet cartridge having a cylindrical unit with a core tube around which the ink sheet is rolled, and an intermediate connector that is attached to one end of the core tube to transmit rotating force to the core tube, the intermediate connector being rotated integrally with the core tube by the rotating force, and a driving force generating system that is adapted to generate the rotating force to rotate the cylindrical unit. The core tube is provided with at least one core tube side engaging portion on an inner peripheral surface thereof. The intermediate connector is provided with at least one connector side engaging portion that is adapted to be engaged, with the at least one core tube side engaging portion. The intermediate connector can be restricted from being separated from the core tube when the at least one core tube side engaging portion and the at least one connector side engaging portion are engaged with each other.

According to some aspects of the invention, an ink sheet set is provided. The ink sheet set includes a cylindrical unit with a core tube around which an ink sheet is rolled, and an intermediate connector that is attached to one end of the core tube. The intermediate connector engages the core tube and are locked using a locking system.

### EMBODIMENTS

Hereinafter, referring to the accompanying drawings, a facsimile machine 1 according to a first illustrative embodiment of the invention will be described.

First, a configuration of the facsimile machine 1, in which an ink sheet cartridge 30 and an exchangeable ink sheet set 23 according to the first embodiment of the invention can be mounted will be described.

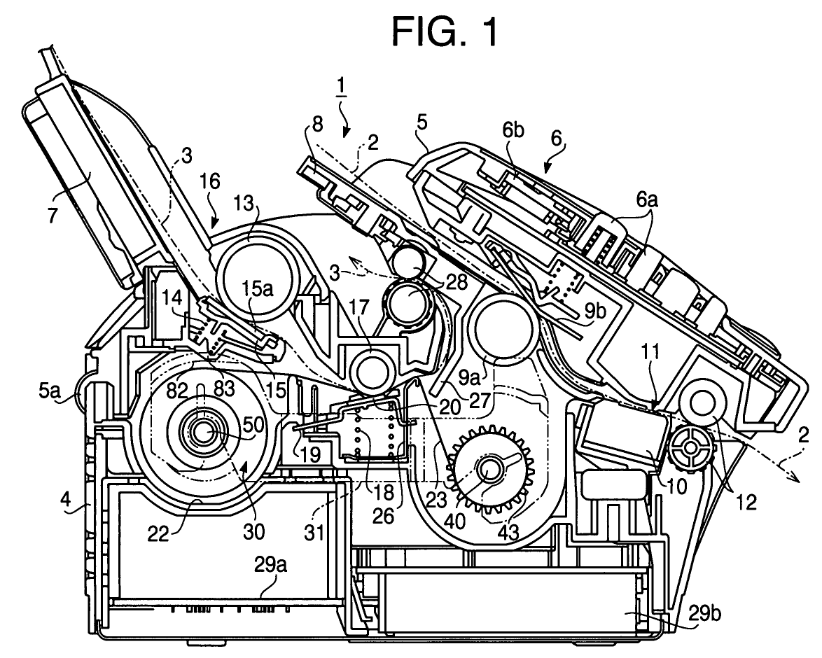

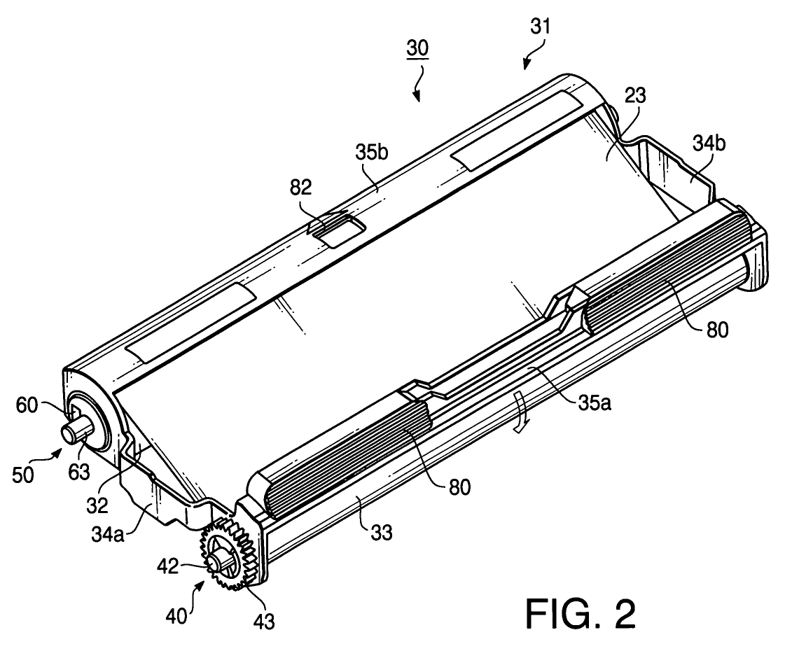

It should be noted that, in the description hereinbelow, the side of the facsimile machine 1 on which an operation panel 6 is provided is referred to as the front (i.e., the right-hand side in FIG. 1), and the side of the ink sheet cartridge 30 on which a take-up spool 40 is provided is referred to as the front (i.e., the lower right-hand side in FIG. 2).

Configuration of the Facsimile Machine

FIG. 1 is a cross-sectional side view of the entire facsimile machine 1. The facsimile machine 1 is configured to function as a facsimile machine and a printer. That is, the facsimile machine 1 reads an original 2 to obtain image data, and transmits the image data to another facsimile machine through communication lines (e.g., phone lines). Also, the facsimile machine 1 receives image data from another facsimile machine through the communication lines and forms an image represented by the received image data on the recording sheet 3. In addition, the facsimile machine 1 receives printing data from external devices, such as a personal computer and a word processor, by wire communication (which uses, for example, a printer cable) or wireless communication (which uses, for example, an infrared rays), and forms an image of the received printing data on the recording sheet 3.

The facsimile machine 1 has a body case 4, an upper cover 5, an operation panel 6, a sheet feed tray 7, and an original stand 8. On one side of the body case 4 (in near front in FIG. 1), a handset (not shown) is provided. The body case 4 has an upper opening. The upper cover 5 is positioned to cover the upper opening of the body case 4. The upper cover 5 is attached to the body case 4 to be pivotally movable in a vertical direction about a pivot point 5a. The sheet feed tray 7 is positioned on the upper rear side of the body case 4 such that it is pivotally movable about an rear end portion of the body case 4. The sheet feed tray 7 holds a stack of recording sheets 3 in a slanted direction such that leading ends of the recording sheets 3 are lower than the trailing ends of the recording sheets 3. The original stand 8 is positioned on the upper intermediate portion of the body case 4.

In the body case 4, a feed roller 9a, a pressure panel 9b to be pressed to the feed roller 9a, a contact type image scanner unit (CIS) 10, an original holder 11, a pair of discharge rollers 12 are provided below the operation panel 6. The feed roller 9a transfers the original 2 toward the CIS 10. The original holder 11 is positioned above the CIS 10 to press the original 2. In the body case 4, a sheet feeding unit 16 is provided below the sheet feed tray 7. The sheet feeding unit 16 includes a sheet supply roller 13 for feeding the recording sheets 3 one by one from the sheet feed tray 7 into an inside of the facsimile machine 1. The sheet feeding unit 16 further includes a separating unit 15. The separating unit 15 is pressed against an upper peripheral surface of the sheet supply roller 13 by a spring 14. The separating unit 15 is configured to fluctuate at the upper end thereof supported by the lower end thereof. A surface of the separating unit 15 facing to the sheet supply roller 13 is provided with a rubber separating pad 15a.

Below the sheet feeding unit 16 are provided a roller shaped platen 17, a spring 18, a heat sink 19, a thermal head 20, and an accommodating unit 22. The thermal head 20 is located on the heat sink 19 and is pressed against a lower peripheral surface of the platen 17 with expanding force of the spring 18. The accommodating unit 22 accommodates therein the ink sheet cartridge 30 in such a manner that the ink sheet cartridge 30 extends from a front side of the heat sink 19 to a rear side of the heat sink 19.

In the accommodating unit 22, the ink sheet cartridge 30 is provided such that a first supply sheet spool 50 is positioned at the rear side of the body case 4 and a first take-up sheet spool 40 is positioned at the front side of the body case 4. Further, a position of the first take-up sheet spool 40 is lower than that of the first supply sheet spool 50. That is, the ink sheet cartridge 30 is positioned in the accommodating unit 22, in a front low and rear high orientation (hip-up orientation).

In the body case 4, below the rear side portion of the accommodating unit 22, a power supply circuit board 29a is provided. The power supply circuit board 29a supplies electricity to operate each part of the facsimile machine 1. In front of the power supply circuit board 29a, a control board 29b, which controls various processes to operate the facsimile machine 1, is arranged.

When an ink sheet 23 is fed from the first supply sheet spool 50 to the first take-up sheet spool 40, the ink sheet 23 passes the thermal head 20 and a top of an ink sheet separating panel 26, and then reaches to a lower peripheral surface of the first take-up sheet spool 40, while an ink surface of the ink sheet 23 facing upward. The recording sheet 3 fed from the sheet feed tray 7 overlaps with the upper surface (ink surface) of the ink sheet 23 between the thermal head 20 and the platen 17, so that an image is formed on the recording sheet 3. Then, the recording sheet 3 passes over an upper surface of a partitioning plate 27, which is formed above the first take-up spool 40 in the ink sheet cartridge 30 to serve as a carrier. Next, the recording sheet 3 is discharged by a pair of discharge rollers 12 toward the back of the facsimile machine 1.

The ink sheet 23 is bent downward at the top of the ink sheet separating panel 26, and passes below the partitioning plate 27 to be rolled around the first take-up sheet spool 40, on the lower periphery of the first take-up spool 40.

Configuration of the Ink Sheet Cartridge

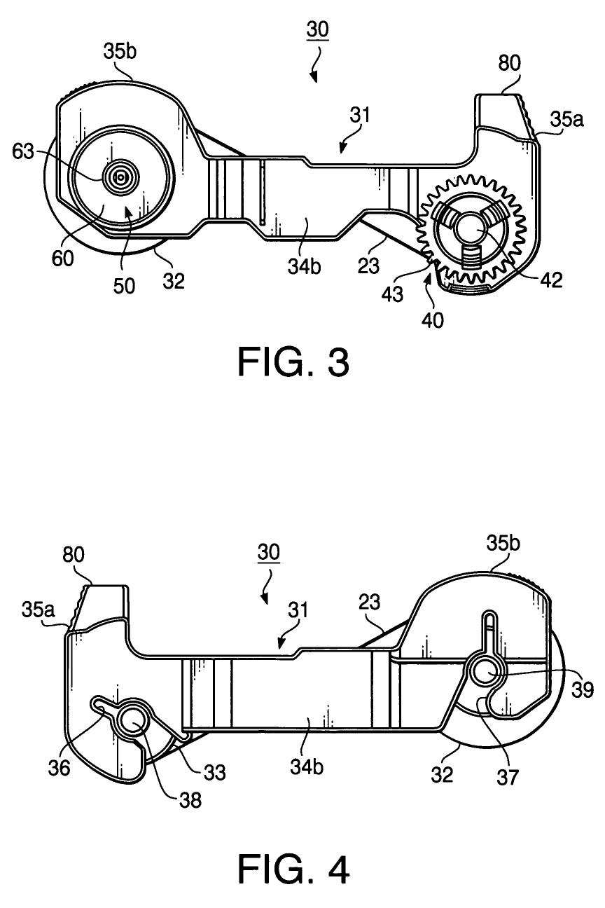

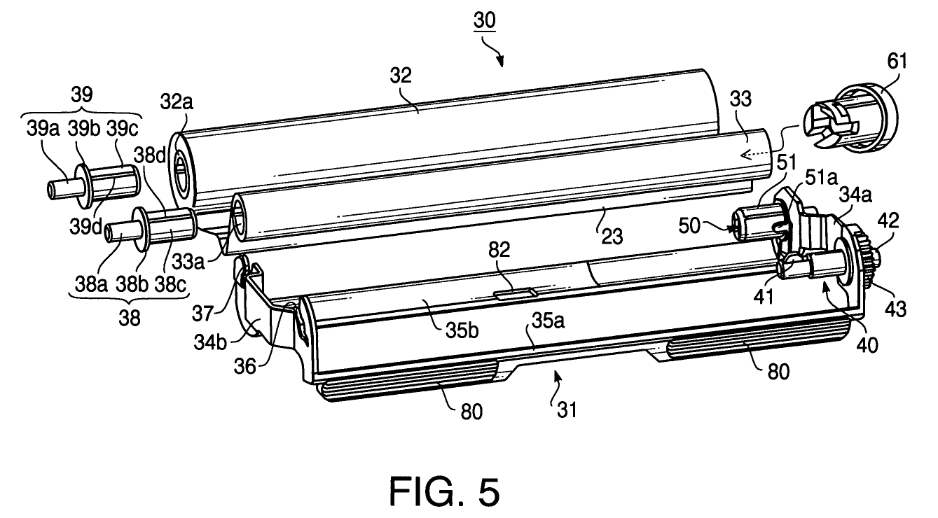

Next, the configuration of the ink sheet cartridge 30 will be described in detail with reference to FIGS. 2 through 5. FIG. 2 is a perspective view of the ink sheet cartridge 30. FIG. 3 is a side view of the ink sheet cartridge 30. FIG. 4 is another side view of the ink sheet cartridge. FIG. 5 is an exploded perspective view of the ink sheet cartridge 30.

The ink sheet cartridge 30 includes a cartridge frame 31, a supply roll 32, an ink sheet 23, and a take-up roll 33. The cartridge frame 31 has a shape of an approximate rectangle. The supply roll 32 includes a supply core tube 32a, around which one end of the ink sheet 23 is rolled. The take-up roll 33 includes a take-up core tube 33a around which the other end of the ink sheet 23 is rolled. The supply roll 32 and the take-up roll 33 are rotatably supported by the cartridge frame 31. The supply roll 32, the take-up roll 33, and the ink sheet 23 are configured to be an ink sheet set. When the ink sheet 23 is exchanged, the ink sheet set including the ink sheet 23 is exchanged.

Once a new ink sheet set is installed in the facsimile machine and an image is printed on the recording sheet 3, the ink sheet 23 is conveyed and rolled around the take-up core tube 33a.

The cartridge frame 31 is made of, for example, polystyrene, and is formed integrally with a pair of side plates 34a and 34b and a pair of coupler portions (i.e., a front coupler 35a and a rear coupler 35b). The side plates 34a and 34b are formed at positions opposite to each other. The front coupler 35a connects the upper portions of the front ends of the side plates 34a and 34b, and the rear coupler 35b connects the upper portions of the rear ends of the side plates 34a and 34b.

On the upper surface of the front coupler 35a is provided with a pair of handles 80, 80. The rear coupler 35b is provided with a rectangular opening 82 in the center in the axial direction. In the opening 82, a spring holder 83 wherein a spring 14 is positioned is settled (see FIG. 1).

Roll receive grooves 36 and 37 are respectively formed in a vicinity to the front end and the rear end of the side plate 34b. The roll receive groove 36 is configured to receive a core 38a of a second take-up spool 38, which is provided with at one end of the take-up core tube 33a, protrusively in the longitudinal direction of the take-up roll 33, so that the core 38a can be rotated therein. The roll receive groove 37 is configured to receive a core 39a of a second supply spool 39, which is provided with at one end of the supply core tube 32a, protrusively in the longitudinal direction of the supply roll 32, so that the core 39a can be rotated therein.

The second take-up spool 38 includes the core 38a, a disk-shaped flange 38b, and an inner cylindrical support 38c that are formed integrally and coaxially. Similarly, the second supply spool 39 includes the core 39a, a disk-shaped flange 39b, and an inner cylindrical support 39c that are formed integrally and coaxially.

Each of the inner cylindrical supports 38c and 39c is respectively provided with a plurality of ribs 38d and 39d, which are extended parallel to the longitudinal axis of the inner cylindrical supports 38c and 39c and evenly spaced on the outer peripheries of the inner cylindrical supports 38c and 39c. The external diameters formed with the ribs 38d and 39d are configured to be slightly greater than the inner diameters of the take-up core tube 33a and the supply core tube 32a respectively. With this configuration, each of the inner cylindrical supports 38c and 39c is inserted and fit into one end of the take-up core tube 33a and the supply core tube 32a securely, so that the take-up roll 33 and the supply roll 32 can be rotated integrally with the inner cylindrical supports 38c and 39c. The second take-up spool 38 and the second supply spool 39 are formed identically and exchangeable to each other.

The side plate 34a of the cartridge frame 31 is provided with the first supply sheet spool 50, which is rotatably supported at a position corresponding to the roll receive groove 37. The first supply sheet spool 50 is inserted into the other end of the supply core tube 32a (the left-hand end of the supply core tube 32a in FIG. 2, and the right-hand end of the same in FIG. 5). The first supply sheet spool 50 includes an inner cylindrical support 51, which is configured to be inserted into the other end of the supply core tube 32a, a spring (not shown), which is placed in the inner cylindrical support 51, and a rotary member 60, which is provided to the cartridge frame 31 from the outside of the side plate 34a.

An engaging tip 51a is provided on the outer periphery of the inner cylindrical support 51. The engaging tip 51a is configured to be engaged with a slit (not shown) provided to the end (the left end of the supply core tube 32a in FIG. 2, and the right end of the same in FIG. 5) of the supply core tube 32a. The rotary member 60 includes a protruded outer cylindrical support 63, which is supported by a roll support groove (not shown). With this configuration, the supply roll 32 is allowed to rotate integrally with the inner cylindrical support 51.

The side plate 34a of the cartridge frame 31 is also provided with the first take-up spool 40, which is rotatably supported at a position corresponding to the roll receive groove 36. The first take-up spool 40 is inserted into the other end of the take-up core tube 33a (the left-hand end of the supply core tube 32a in FIG. 2, and the right-hand end of the same in FIG. 5). The first take-up spool 40 is unreleasably installed into a shaft hole 25 of the side plate 34a.

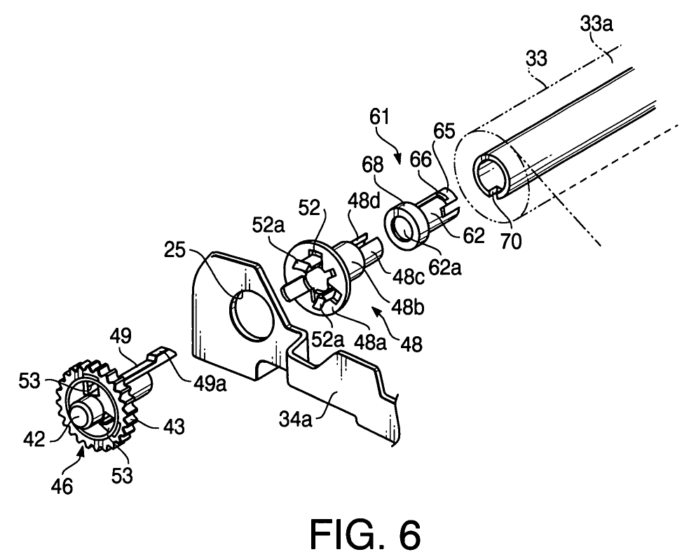

As seen in FIG. 6, the first take-up spool 40 includes a first rotation member 46 with an input gear 43, which is arranged outside of the side plate 34a when installed and a flanged shaft member 48, which is connected to the first rotation member 46 from the inside of the side plate 34a.

As seen in FIGS. 5 and 6, the first take-up spool 40 and the take-up core tube 33a are interconnected through the intermediate connector 61 when the flanged shaft member 48 is detachably attached to the intermediate connector 61, which is inserted into the take-up core tube 33a. The first rotation member 46 and the flanged shaft member 48, each formed from synthetic resin, such as resin, are produced by injection molding.

The first rotation member 46 is provided with a projection 42 (see FIG. 6). The input gear 43 is formed to surround the projection 42. When the ink sheet cartridge 30 is installed in the facsimile machine 1, the input gear 43 is engaged with an output gear (not shown), which is driven by a driving motor (not shown) of the facsimile machine 1.

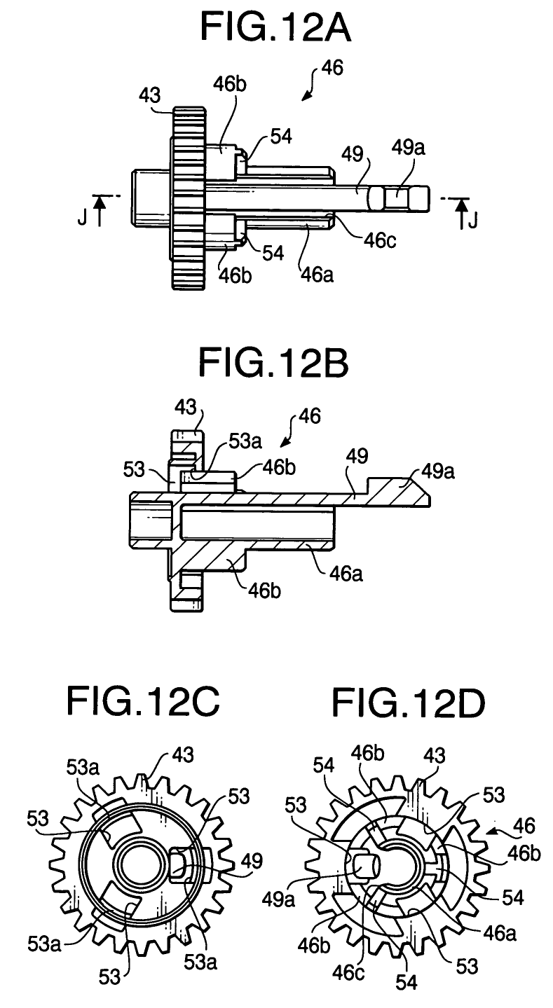

FIGS. 12A-12C illustrate diagrams of the first rotation member 46. FIG. 12A shows a side plane view of the first rotation member 46. FIG. 12B shows a cross-sectional side view of the first rotation member 46 taken along the line J-J in FIG. 12A. FIG. 12C is a right side view of the first rotation member 46 seen from the right-hand side shown in FIG. 12A, and FIG. 12D is a left side view of the first rotation member 46 viewed from the left-hand side shown in FIG. 12A.

On the inner peripheral surface of the input gear 43, a rod-like resilient member 49 may be integrally formed. The resilient member 49 extends through a slot 46c of an inner sleeve 46a (see FIG. 12C). Both the slot 46c and the resilient member 49 extend in the axial direction. The resilient member 49 has a free end integrally provided with an engagement pawl 49a, which projects radially outwardly. On the radially outer side of the inner sleeve 46a, three fan-shaped portions 46b are formed. As shown in FIGS. 12B through 12D, three fitting holes 53 are formed between neighboring fan-shaped portions 46b. The three fitting holes 53 engage with engaging pawls 52a of engaging members 52, which are respectively formed at end portions of the engaging members 52 for locking engagement with the stepped portions 53a of the first rotation member 46. The stepped portions 53a are provided at radially outer side of the fitting holes 53. As shown in FIGS. 12A and 12C, the fan-shape portions 46b are integrally provided with positioning projections 54.

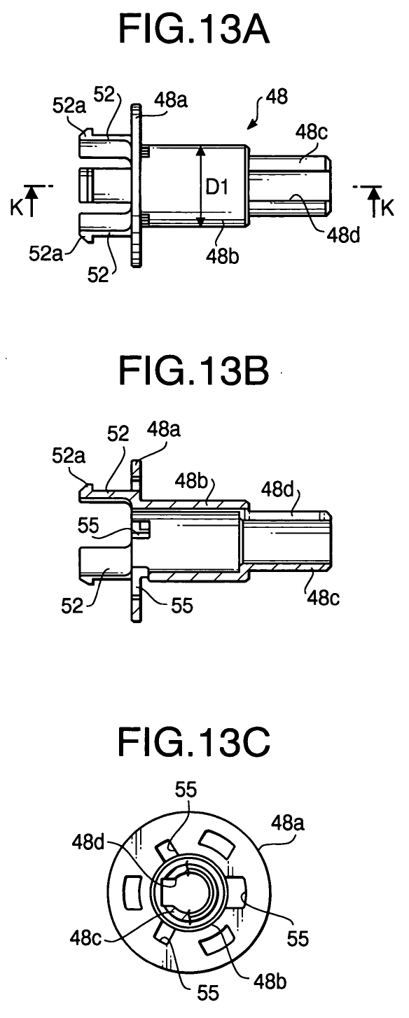

FIGS. 13A-13C illustrate diagrams of the flanged shaft member 48. FIG. 13A shows a side plane view of the flanged shaft member 48. FIG. 13B shows a cross-sectional view of the flanged shaft member 48 taken along the line K-K in FIG. 13A. FIG. 13C shows a right side view of the flanged shaft member 48 seen from the right-hand side shown in FIG. 13A.

The shaft member 48 has a flange 48a, which is provided with a sleeve base 48b, on an inner peripheral surface thereof, extending in the axial direction. At a tip portion of the sleeve base 48b, a guide portion 48c extending in the axial direction and having a diameter smaller than that of the sleeve base 48b is formed. When the first rotation member 46 and the shaft member 48 are engaged with each other, the resilient member 49 and the engagement pawl 49a of the first rotation member 46 penetrate through the inner space of the sleeve base 48b and the guide portion 48c.

Three engaging members 52 extend from a radially intermediate portion of the flange 48a in a direction opposite to the sleeve base 48b. Positioning holes 55 are formed on the flange 48a for engagement with the positioning projections 54 of the first rotation member 46 (see FIGS. 13B and 13C).

With the above arrangement, the first rotation member 46 and the flanged shaft member 48 are fitted to the shaft hole 25 of the side plate 34a in the following manner. As shown in FIGS. 5 and 6, the resilient member 49 of the first rotation member 46 is inserted into the shaft hole 25 from the outside of the side plate 34a. Next, the three engaging members 52 of the flanged shaft member 48 are inserted into the shaft holes 25 of the first rotation member 46 from the inner side of the side plate 34a while holding the side plate 34a between the first rotation member 46 and the flanged shaft member 48. Consequently, the engagement pawl 52a of each engaging member 52 is brought into locking engagement with each fitting hole 53.

Thus, the first rotation member 46 and the flanged shaft member 48 are integrally connected together as the first take-up spool 40, and held at the shaft holes 25 unreleasable from the cartridge frame 31.

Configuration of the Intermediate Connector 61 and the Take-Up Core Tube 33a

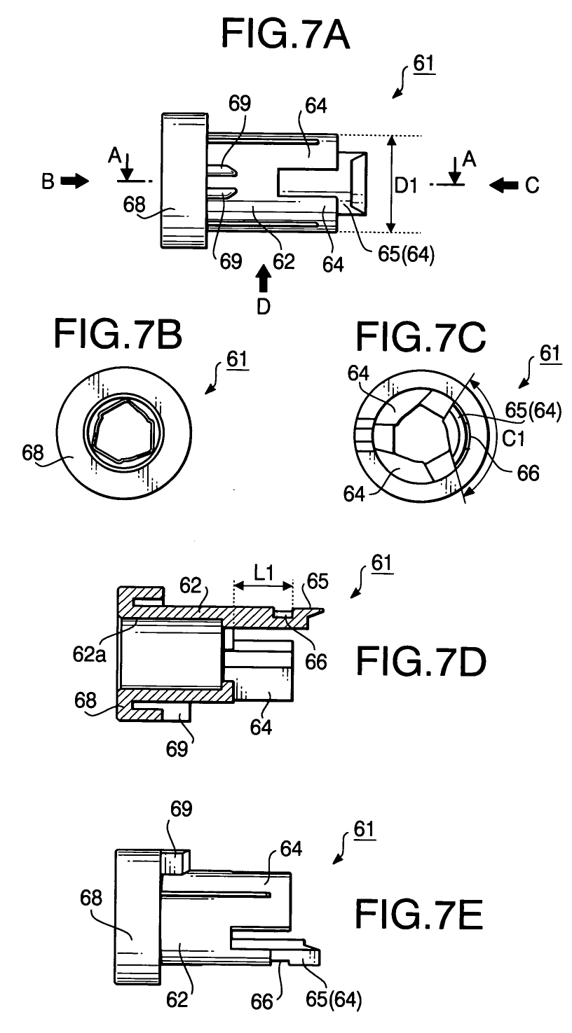

A configuration of the intermediate connector 61 will be described in detail with reference to FIGS. 7A through 7E. FIG. 7A shows a side view of the intermediate connector 61. FIG. 7B shows a side view of the intermediate connector 61 viewed from a direction indicated by an arrow B in FIG. 7A. FIG. 7C shows another side view of the intermediate connector 61 viewed from a direction indicated by an arrow C in FIG. 7A. FIG. 7D shows a cross-sectional view of the intermediate connector 61 taken along the line A-A in FIG. 7A. FIG. 7E shows a front view of the intermediate connector 61.

The intermediate connector 61 is formed integrally and made of, for example, ABS (acrylonitrile butadiene styrene) resin. As shown in FIGS. 7A through 7E, the intermediate connector 61 includes a cylindrical base 62 with an external diameter D1. The cylindrical base 62 is integrally formed with three cam segments 64 at a tip portion thereof. The three cam segments 64 are arranged in a circumferential direction of the cylindrical base 62. An inner peripheral surface 62a of a base end portion of the cylindrical base 62 is configured to have a diameter that is substantially equal to a diameter of the sleeve base 48b of the flanged shaft member 48, so that the sleeve base 48b is rotatably fitted into the inner peripheral surface 62a (see FIGS. 7D and 6).

The intermediate connector 61 has a maximum diameter portion 68 of which a diameter thereof is equal to an external diameter of the take-up core tube 33a. The cylindrical base 62 is formed with two protruding segments 69, which protrude outward with respect to the outer diameter of the cylindrical base 62. At one end of the take-up core tube 33a where the intermediate connector 61 is attached, a cutout groove 70, in which the protruding segments 69 are configured to be inserted is formed. With this configuration, the take-up core tube 33a is rotated integrally with the intermediate connector 61. It should be noted that the number of the protruding segments 69 is not limited to two, but may be one or three, for example.

In the present embodiment, one of the three cam segments 64 is formed as a rib 65, which is extended from the cylindrical base 62 to connect the intermediate connector 61 and the take-up core tube 33a. The rib 65 has a recessed portion 66 on an outer peripheral surface thereof.

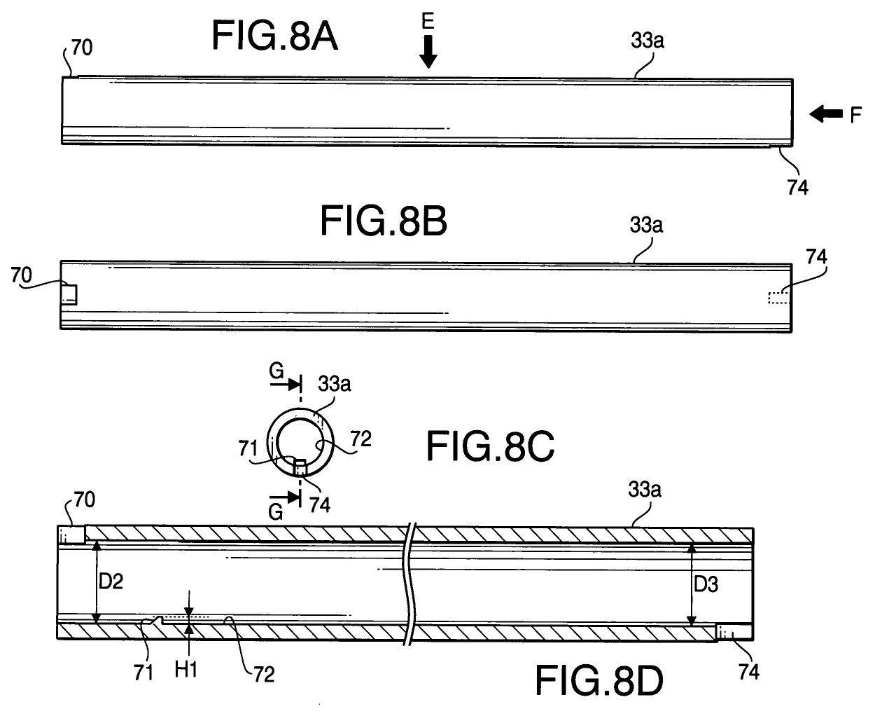

A configuration of the take-up core tube 33a will be described in detail with reference to FIGS. 8A through 8D. FIGS. 8A-8D illustrate diagrams of the take-up core tube 33a. FIG. 8A shows a front view of the take-up core tube 33a. FIG. 8B shows a side view of the take-up core tube 33a viewed from a direction indicated by an arrow E in FIG. 8A. FIG. 8C shows another side view of the take-up core tube 33a seen from a direction indicated by an arrow F in FIG. 8A. FIG. 8D shows a cross-sectional view of the take-up core tube 33a taken along the line G-G in FIG. 8C.

The take-up core tube 33a has a shape of a cylinder and is made of resin. At one end of the take-up core tube 33a where the intermediate connector 61 is attached, the cutout groove 70 is formed, and at the other end of the take-up core tube 33a, a mating groove 74 is formed. The width of the mating groove 74 in the direction along the outer periphery of the take-up core tube 33a is configured to be smaller than the width of the cutout groove 70, so that the intermediate connector 61 is not allowed to be inserted to the take-up core tube 33a from the end with the mating groove 74 by mistake.

An inner diameter D3 of the take-up core tube 33a in a vicinity of the end where the mating groove 74 is formed is configured to be smaller than an inner diameter D2 of the take-up core tube 33a in a vicinity of the other end where the cutout groove 70 is formed. The inner diameter D2 is configured to be substantially equal to the external diameter D1 of the cylindrical base 62. As the inner diameter D3 of the take-up core tube 33a is smaller than the external diameter D1 of the cylindrical base 62, which is substantially equal to the inner diameter D2, the cylindrical base 62 is configured not to be inserted completely and correctly to the take-up core tube 33a through the end where the mating groove 74 is formed.

With the above configuration and the configuration of the mating groove 74 of which the width thereof is smaller than the width of the cutout groove 70, the intermediate connector 61 is configured to be inserted into only to the correct end of the take-up core tube 33a, and not to be inserted into the incorrect end by mistake.

As seen in FIGS. 8C and 8D, an engaging protrusion 71 protruding from the surface of the inner periphery 72 of the take-up core tube 33a toward the center of the diameter of the take-up core tube 33a is formed. In the present embodiment, height of the engaging protrusion 71 (from the surface of the inner periphery 72 toward the center of the diameter) is configured to be 1.05 mm, however, the height is not limited to this, as long as the height is in a specific range, which will be described hereinbelow.

The length of the rib 65 (hereinafter referred to as L1) from the cylindrical base 62 to the recessed portion 66, particularly from the boundary between the cylindrical base 62 and the rib 65 to an edge that is closer to the tip of the rib 65 is configured to be 7.8 mm (see FIG. 7D), however, the length L1 is not limited to this, as long as the length is in a specific range, which will be described hereinbelow.

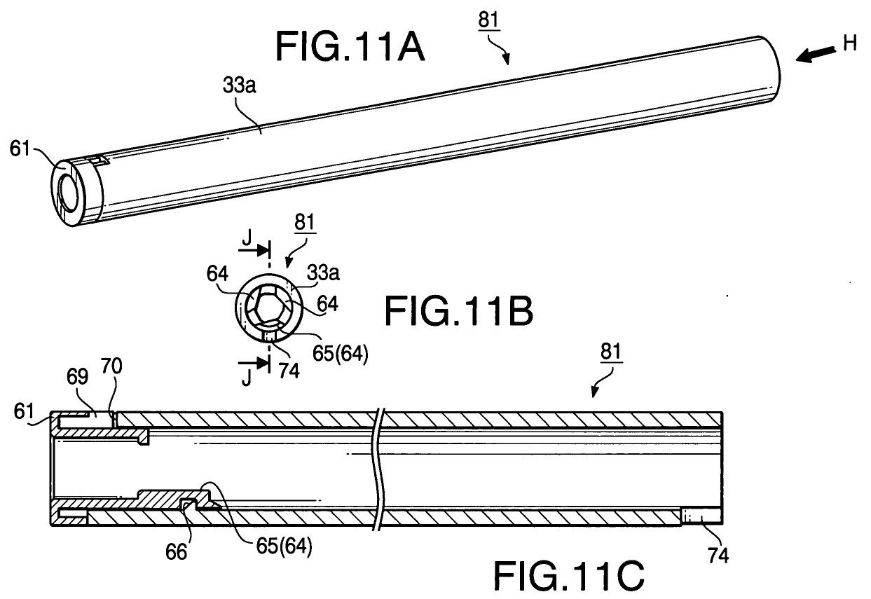

FIGS. 11A-11C illustrate diagrams of a take-up cylinder 81 with the intermediate connector 61 inserted therein. FIG. 11A shows a perspective view of the take-up cylinder 81. FIG. 11B shows a cross-sectional view of the take-up cylinder 81 viewed from the right-hand side indicated by an arrow H in FIG. 11A. FIG. 11C shows a cross-sectional view of the take-up cylinder 81 taken along the line J-J in FIG. 11B.

When the intermediate connector 61 and the take-up core tube 33a are in engagement with each other in a manner that will be described hereinbelow, each of the two protruding segments 69 is fitted in the cutout groove 70, and the take-up core tube 33a and the intermediate connector 61 define the take-up cylinder 81. As seen in FIG. 11C, inside the take-up core tube 33a, the rib 65 of the intermediate connector 61 is extended in the longitudinal direction from the cylindrical base 62, along the surface of the inner periphery 72 toward the center of the take-up core tube 33a.

The engaging protrusion 71 is caught in the recessed portion 66 of the rib 65, which is formed in a position opposed to the engaging protrusion 71. With this configuration, movement of the intermediate connector 61 in the longitudinal direction is restricted, and the intermediate connector 61 and the take-up core tube 33a become unreleasable from each other.

The guide portion 48c of the flanged shaft member 48 is rotatably fitted into inner peripheral surfaces of the three cam segments 64 of the intermediate connector 61. As described above, the engagement pawl 49a of the resilient member 49 protrudes outwardly in the radial direction from the guide portion 48c. Therefore, when the flanged shaft member 48 (i.e., the engagement pawl 49a) rotates in a direction that the engagement pawl 49a slidingly moves on the inner peripheral surface of the can segments 64 against resilient force of the resilient member 49, the intermediate connector 61 stays still without rotating even when the resilient member 49 (i.e., the shaft member 48) rotates. On the other hand, when the flanged shaft member 48 along with the resilient member 49 rotates in the opposite direction, the engagement pawl 49a is brought in abutment with one of short surfaces of the cam segments 64 and in engagement with one of spaces formed between adjacent two cam segments 64. In this case, the intermediate connector 61 rotates along with the rotation of the shaft member 48.

Process to Insert the Intermediate Connector 61 into the Take-Up Core Tube 33a

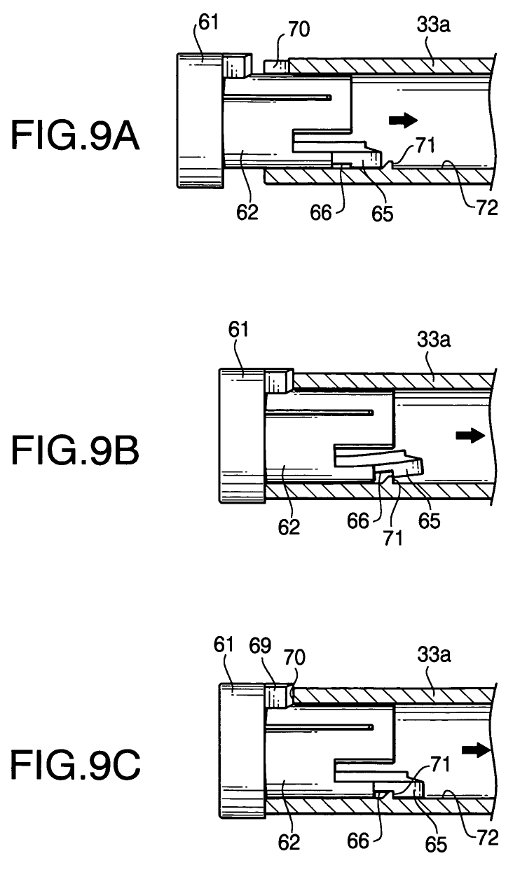

Referring to FIGS. 9A through 9C, a process to insert the intermediate connector 61 into the take-up core tube 33a is described. When the intermediate connector 61 is pressed and inserted into the take-up core tube 33a in a direction indicated by an arrow in FIG. 9A through one end thereof, on which the engaging protrusion 71 is formed, the three cam segments 64 including the rib 65 contact the engaging protrusion 71.

It should be noted that the cross-sectional surface of the side of the engaging protrusion 71 may be formed to have a shape of an approximate right triangle (see also FIG. 8D), of which hypotenuse is inclined downwardly toward the end of the take-up core tube 33a where the intermediate connector 61 is inserted. With this configuration, as the intermediate connector 61 continues to be inserted, the rib 65 is resiliently deformed by the engaging protrusion 71 and bent toward the center of the diameter of the take-up core tube 33a. The deformation increases as the rib 65 is further pressed and proceeds inside the take-up core tube 33a, and is maximized when the edge of the recessed portion 66 that is closer to the tip of the rib 65 comes to the peak of the engaging protrusion 71 (see FIG. 9B). As seen in FIG. 9B, the edge of the recessed portion 66 closer to the tip of the rib 65 reaches to a height that is substantially equal to the height H1 of the engaging protrusion 71. When the intermediate connector 61 is pressed further, the engaging protrusion 71 is caught in the recessed portion 66, and the fib 65 recovers to the original form.

Interrelation between the Length L1 of the Rib 65 and the Height H1 of the Engaging Protrusion 71

As described above, the length L1 of the rib 65 is configured to be 7.8 mm, while the height H1 of the engaging protrusion 71 is configured to be 1.05 mm in the present embodiment. The length L1 and the height H1 are configured so that when the engaging protrusion 71 is engaged with the recessed portion 66, possible stress to the rib 65 caused by the deformation is less than and close to the maximum allowable stress.

If, for example, the engaging protrusion 71 is simply engaged with the recessed portion 66, the engagement can be obtained by configuring the engaging protrusion 71 to be smaller in height than the height H1 in the present embodiment and the rib 65 to be bent slightly. The engagement may also be obtained by, for example, forming the length of the rib 65 to be longer than the length L1 of the present embodiment. In this case, stress applied to the rib caused by the deformation is less than the stress applied to the rib 65 in the present embodiment.

It should be noted, however, the rib 65 is configured to deform at the maximum resiliency thereof, so that the engaging protrusion 71 and the recessed portion 66 are more securely engaged with each other. The height H1 and the length L1 described above, which are 1.05 mm for H1 and 7.8 mm for L1, are one example that represents the interrelation between the height of the engaging protrusion 71 and the length of the rib 65 to obtain the secure engagement. The maximum allowable stress refers to the greatest value of the stress in a range that allows the deformed rib 65 to recover to the original form thereof. When stress greater than the maximum allowable stress is applied to the rib 65, the rib 65 is plastically deformed.

When the height H1 and the length L1 are configured, it should be noted that a circumferential length C1 (see FIG. 7C) of the rib 65 at the boundary with the cylindrical base 62 is considered. In the present embodiment, one of the three cam segments 64 is formed as the rib 65, and the circumferential length C1 is configured to be in a range from approximately ⅕ to ¼ of the entire circumferential length of the cylindrical base 62.

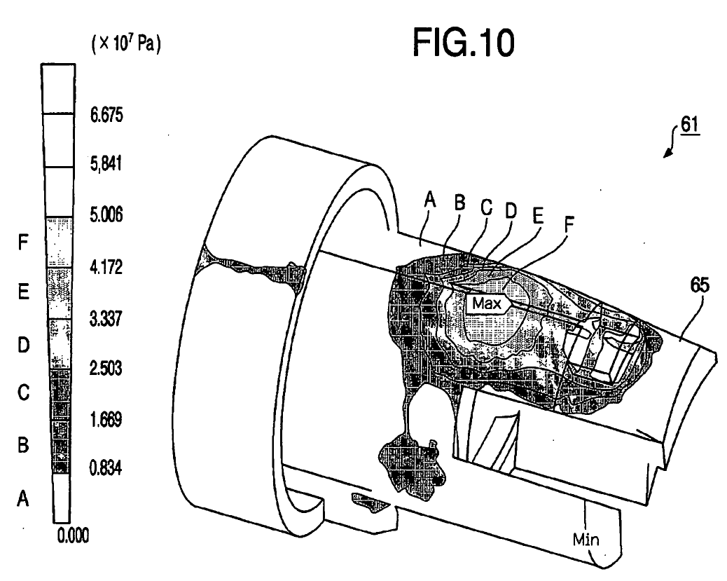

FIG. 10 illustrates a stress distribution in the intermediate connector 61 when the engaging protrusion 71 and the recessed portion 66 come to an engagement, and the rib 65 is deformed at the maximum resiliency. In this configuration, the edge of the recessed portion 66 that is closer to the tip of the rib 65 is raised for 1.05 mm from the surface of the inner periphery 72. The stress, i.e., 44 MPa in this embodiment, is greatest at the vicinity of the boundary between the cylindrical base 62 and the rib 65, and spreads diminishingly, while the maximum allowable stress to the rib 65 at the boundary between the cylindrical base 62 is approximately 46 MPa in the present embodiment.

As described above, the maximum stress to the rib 65 at the maximum resiliency is 44 MPa, which is less than and close enough (for example greater than or equal to 70% of the maximum allowable stress) to the maximum allowable stress (i.e., 46 MPa). Thus, the engaging protrusion 71 and the recessed portion 66 are securely engaged, and secure connection between the intermediate connector 61 and the take-up core tube 33a is obtained.

It should be noted that the above-described height H1 of the engaging protrusion 71 is not limited to 1.05 mm, as long as the height is in a range from 0.95 mm to 1.1 mm, for example. It should be also noted that the length L1 of the rib 65 is not limited to 7.8 mm. The length L1 is a length corresponding to the height H1 that is in the range described above and the circumferential length C1 that is in a range from approximately 1/10 to ¼ of the entire circumferential length of the cylindrical base 62. When the height H1 and the circumferential length C1 are set in the ranges described above, the length L1 of the rib 65 can be configured to be in a range from 7.5 mm to 15 mm, for example. In this case, if the length L1 is configured to be in a particular range, that is from 7.8 mm to 8.8 mm, the engaging protrusion 71 and the recessed portion 66 are more securely engaged.

Thus, the intermediate connector 61 and the take-up core tube 33a of the facsimile machine 1 are securely connected to each other, and the external rotating force transmitted to the first take-up spool 40 is effectively transmitted to the take-up core tube 33a via the intermediate connector 61.

It should be noted that the engaged portion are configured inside the take-up core tube 33a and not exposed, therefore, an incidental shock or contact to the engaged portion, which is for example caused by the user during the exchange of the ink sheets, can be avoided, and the engagement of the intermediate connector 61 and the take-up core tube 33a is maintained.

As the recessed portion 66 is formed in the rib 65, and the engaging protrusion 71 is formed in the take-up core tube 33a, the take-up core tube 33a can be formed in a less complicated manner than a manner in which a take-up core tube with a recessed portion is formed.

The length L1 of the rib 65, the height H1 of the engaging protrusion 71, and the circumferential length C1 of the rib 65 are configured as described above, so that the possible stress to the rib 65 caused by the deformation when the intermediate connector 61 is inserted is less than and close to the maximum allowable stress. This configuration results the intermediate connector 61 and the take-up core tube 33a of the facsimile machine 1 to be securely connected to each other, and the external rotating force transmitted to the first take-up spool 40 to be effectively conveyed to the take-up core tube 33a via the intermediate connector 61.

As the width of the mating groove 74 in the direction along the outer periphery of the take-up core tube 33a, formed at one of the ends of the take-up core tube 33a to which the intermediate connector 61 is not attached, is configured to be smaller than the width of the cutout groove 70, therefore, the intermediate connector 61 is not allowed to be inserted by mistake to the take-up core tube 33a from the incorrect end.

The take-up core tube 33a is formed integrally and made of resin, therefore, the take-up core tube 33a can be formed in a less complicated method than a method in which a take-up core tube is formed in a metal, for example iron and aluminum. In addition, the take-up core tube 33a made of resin is more advantageous in reduction of weight and production cost.

It should be noted an embodiment of the present invention is not limited by the above described embodiment, and can be configured in numerous variations and permutations of the above described devices that fall within the spirit and scope of the invention.

For example, the intermediate connector 61 is made of ABS resin in the above described embodiment. However, the intermediate connector 61 may be made of another material, and the length of the rib 65 (L1) may be modified according to the material. In such case, it is preferable that the maximum stress to the rib 65 caused by the deformation is configured to be less than and close to the maximum allowable stress for the material.

The material for the take-up core tube 33a is not limited to resin. Although the take-up core tube 33a in the present embodiment is made of resin, the take-up core tube 33a may be made of a metal, for example. In such case, the height H1 of the engaging protrusion 71 may be determined based on the material of the rib 65 and the length L1 thereof.

Although the cylindrical base 62 in the present embodiment is provided with the three cam segments 64, one of which is formed as the rib 65, the number of the cam segments 64 is not limited to three, but may be, for example, two or more than three.

Further, the rib 65 may not necessarily be one of the plurality of cam segments 64. The rib 65 may be formed individually from the cam segments 64.

For the engagement of the intermediate connector 61 and the take-up core tube 33a, the recessed portion 66 may be formed on the surface of the inner periphery 72 of the take-up core tube 33a, while the engaging protrusion 71 may be formed with the rib 65. However, as described above, it may be less complicated, and thus preferable, to form the take-up core tube 33a with the recessed portion 66 than to form the take-up core tube 33a with the engaging protrusion 71.

Although in the above described configurations of the ink sheet cartridge 30 and the exchangeable ink sheet set are applied to the facsimile machine 1, the configurations of the ink sheet cartridge 30 and the exchangeable ink sheet set according to the embodiment can also be applied to various types of image forming devices such as a printer, a copying machine or a multi-function device.

In the above described embodiment, the intermediate connector 61 is interposed between the first take-up spool 40 and the take-up core tube 33a. However, the intermediate connector 61 may be located between one of spools and a corresponding end portion of a core tube. Alternatively, a plurality of intermediate connectors may be provided at the end portions of the core tubes 32a and 33a.

In the above described embodiment, a pair of one engaging protrusion 71 and a recessed portion 66 is provided to connect the intermediate connector 61 to the end portion of the core tube 33a. A plurality of pairs of engaging protrusions 71 and recessed portions 66 may be provided to connect the intermediate connector 61 to the end portion of the core tube 33a.

Although examples of carrying out the invention have been described, those skilled in the art will appreciate that there are numerous variations and permutations of the above described devices that fall within the spirit and scope of the invention as set forth in the appended claims. It is to be understood that the subject matter defined in the appended claims is not necessarily limited to the specific features or act described above. Rather, the specific features and acts described above are disclosed as example forms of implementing the claims.

What is claimed is:

1. A cylindrical unit, comprising:
a core tube around which an ink sheet is rolled; and
an intermediate connector that is attached to one end of the core tube to transmit external rotating force to the core tube, the intermediate connector being rotated integrally with the core tube by the rotating force,
wherein the core tube is provided with at least one core tube side engaging portion on an inner peripheral surface thereof,
wherein the intermediate connector is provided with at least one connector side engaging portion that is adapted to be engaged with the at least one core tube side engaging portion, and
wherein the intermediate connector is restricted from being separated from the core tube when the at least one core tube side engaging portion and the at least one connector side engaging portion are engaged with each other.

2. The cylindrical unit according to claim 1,
wherein the at least one core tube side engaging portion is formed as a male engaging portion that protrudes from the inner peripheral surface of the core tube toward a center of a diameter of the core tube,
wherein the at least one connector side engaging portion is formed as a female engaging portion that is recessed at a location corresponding to the male engaging portion, and,
wherein the intermediate connector is restricted from being separated from the core tube when the male engaging portion and the female engaging portion are engaged with each other.

3. The cylindrical unit according to claim 2,
wherein the intermediate connector includes an inserted portion that is inserted into the inside of the core tube, and a rib portion that is extended in a longitudinal direction from the inserted portion, the rib portion being resiliently deformed toward the center of the diameter of the core tube by stress caused by the at least one male engaging portion,
wherein the female engaging portion is formed on a surface of the rib portion at a position opposed to the inner peripheral surface of the core tube.

4. The cylindrical unit according to claim 3,
wherein the intermediate connector is configured to be resiliently deformed by stress caused by the at least one male engaging portion when the rib portion is inserted into the core tube and to be raised from the inner peripheral surface of the core tube to a height of the male engaging portion, and to recover to an original form thereof when the rib portion is further inserted during a process to engage the intermediate connector with the core tube, and
wherein the height of the male engaging portion and a length of the rib portion from a boundary between the inserted portion and the rib portion to an edge of the female engaging portion that is closer to a tip of the rib portion are configured so that when the male engaging portion and the female engaging portion are being engaged with each other, possible temporal stress to the rib portion caused by being deformed is smaller than and close to a maximum allowable stress to the rib portion.

5. The cylindrical unit according to claim 4,
wherein the intermediate connector is made of resin, and
wherein the height of the male engaging portion from the inner peripheral surface toward the center of the diameter of the core tube is in a range from 0.95 mm to 1.1 mm.

6. The cylindrical unit according to claim 5,
wherein a circumferential length of the rib portion at the boundary with the inserted portion is configured to be in a range from 1/10 to ¼ of an entire circumferential length of the inserted portion, and
wherein the length of the rib portion from the boundary between the inserted portion and the rib portion to the edge of the female engaging portion is configured to be in a range from 7.5 mm to 15 mm.

7. The cylindrical unit according to claim 6,
wherein the length of the rib portion from the boundary between the inserted portion and the rib portion to the edge of the female engaging portion is configured to be in a range from 7.8 mm to 8.8 mm.

8. The cylindrical unit according to claim 1,
wherein the at least one core tube side engaging portion is provided in a vicinity of a first end of two ends of the core tube, and
wherein the intermediate connector is allowed to be attached to the first end of the core tube, and the intermediate connector is prevented from being attached to a second end of the core tube.

9. The cylindrical unit according to claim 8,
wherein an inner diameter of the core tube at the second end is configured to be smaller than an inner diameter of the core tube at the first end, so that the intermediate connector is correctly inserted into the core tube.

10. The cylindrical unit according to claim 1,
wherein the intermediate connector is provided with a maximum diameter portion of which a diameter thereof is equal to an external diameter of the core tube, and at least one protruding segment that is inserted in a groove formed on the core tube.

11. The cylindrical unit according to claim 1, wherein the core tube is integrally formed of resin.

12. An ink sheet cartridge comprising:
a cylindrical unit with a core tube around which an ink sheet is rolled, and an intermediate connector that is attached to one end of the core tube to transmit external rotating force to the core tube, the intermediate connector being rotated integrally with the core tube by the rotating force,
wherein the core tube is provided with at least one core tube side engaging portion on an inner peripheral surface thereof,
wherein the intermediate connector is provided with at least one connector side engaging portion that is adapted to be engaged with the at least one core tube side engaging portion, and
wherein the intermediate connector is restricted from being separated from the core tube when the at least one core tube side engaging portion and the at least one connector side engaging portion are engaged with each other.

13. The ink sheet cartridge according to claim 12,
wherein the at least one core tube side engaging portion is formed as a male engaging portion that protrudes from the inner peripheral surface of the core tube toward a center of a diameter of the core tube,
wherein the at least one connector side engaging portion is formed as a female engaging portion that is recessed at a location corresponding to the male engaging portion, and,
wherein the intermediate connector is restricted from being separated from the core tube when the male engaging portion and the female engaging portion are engaged with each other.

14. The ink sheet cartridge according to claim 13,
wherein the intermediate connector includes an inserted portion that is inserted into the inside of the core tube, and a rib portion that is extended in a longitudinal direction from the inserted portion, the rib portion being resiliently deformed toward the center of the diameter of the core tube by stress caused by the at least one male engaging portion.

15. The ink sheet cartridge according to claim 12,
wherein the at least one core tube side engaging portion is provided in a vicinity of a first end of two ends of the core tube, and
wherein the intermediate connector is allowed to be attached to the first end of the core tube, and the intermediate connector is prevented from being attached to a second end of the core tube.

16. The ink sheet cartridge according to claim 15,
wherein an inner diameter of the core tube at the second end is configured to be smaller than an inner diameter of the core tube at the first end, so that the intermediate connector is correctly inserted into the core tube.

17. The ink sheet cartridge according to claim 12,
wherein the intermediate connector is provided with a maximum diameter portion of which a diameter thereof is equal to an external diameter of the core tube, and at least one protruding segment that is inserted in a groove formed on the core tube.

18. An ink sheet set comprising:
a cylindrical unit with a core tube around which an ink sheet is rolled, and an intermediate connector that is attached to one end of the core tube to transmit external rotating force to the core tube, the intermediate connector being rotated integrally with the core tube by the rotating force,
wherein the core tube is provided with at least one core tube side engaging portion on an inner peripheral surface thereof,
wherein the intermediate connector is provided with at least one connector side engaging portion that is adapted to be engaged with the at least one core tube side engaging portion, and
wherein the intermediate connector is restricted from being separated from the core tube when the at least one core tube side engaging portion and the at least one connector side engaging portion are engaged with each other.

19. The ink sheet set according to claim 18,
wherein the at least one core tube side engaging portion is formed as a male engaging portion that protrudes from the inner peripheral surface of the core tube toward a center of a diameter of the core tube,
wherein the at least one connector side engaging portion is formed as a female engaging portion that is recessed at a location corresponding to the male engaging portion, and,
wherein the intermediate connector is restricted from being separated from the core tube when the male engaging portion and the female engaging portion are engaged with each other.

20. The ink sheet set according to claim 19,
wherein the intermediate connector includes an inserted portion that is inserted into the inside of the core tube, and a rib portion that is extended in a longitudinal direction from the inserted portion, the rib portion being resiliently deformed toward the center of the diameter of the core tube by stress caused by the at least one male engaging portion.

21. The ink sheet set according to claim 18,
wherein the at least one core tube side engaging portion is provided in a vicinity of a first end of two ends of the core tube, and
wherein the intermediate connector is allowed to be attached to the first end of the core tube, and the intermediate connector is prevented from being attached to a second end of the core tube.

22. The ink sheet set according to claim 21,
wherein an inner diameter of the core tube at the second end is configured to be smaller than an inner diameter of the core tube at the first end, so that the intermediate connector is correctly inserted into the core tube.

23. The ink sheet set according to claim 18,
wherein the intermediate connector is provided with a maximum diameter portion of which a diameter thereof is equal to an external diameter of the core tube, and at least one protruding segment that is inserted in a groove formed on the core tube.

24. An imaging apparatus comprising:
an ink sheet cartridge including a cylindrical unit with a core tube around which an ink sheet is rolled, and an intermediate connector that is attached to one end of the core tube to transmit rotating force to the core tube, the intermediate connector being rotated integrally with the core tube by the rotating force, and
a driving force generating system that is adapted to generate the rotating force to rotate the cylindrical unit,
wherein the core tube is provided with at least one core tube side engaging portion on an inner peripheral surface thereof,
wherein the intermediate connector is provided with at least one connector side engaging portion that is adapted to be engaged, with the at least one core tube side engaging portion, and
wherein the intermediate connector is restricted from being separated from the core tube when the at least one core tube side engaging portion and the at least one connector side engaging portion are engaged with each other.

25. The imaging apparatus according to claim 24,
wherein the at least one core tube side engaging portion is formed as a male engaging portion that protrudes from the inner peripheral surface of the core tube toward a center of a diameter of the core tube,
wherein the at least one connector side engaging portion is formed as a female engaging portion that is recessed at a location corresponding to the male engaging portion, and,
wherein the intermediate connector is restricted from being separated from the core tube when the male engaging portion and the female engaging portion are engaged with each other.

26. The imaging apparatus according to claim 25,
wherein the intermediate connector includes an inserted portion that is inserted into the inside of the core tube, and a rib portion that is extended in a longitudinal direction from the inserted portion, the rib portion being resiliently deformed toward the center of the diameter of the core tube by stress caused by the at least one male engaging portion.

27. An ink sheet cartridge comprising:
a cylindrical unit with a core tube around which an ink sheet is rolled, and an intermediate connector that is attached to one end of the core tube,
wherein the intermediate connector engages the core tube and are locked using a locking system.
